(19) United States
(12) Patent Application Publication
(10) Pub. No.: US 2010/0100892 A1
(43) Pub. Date: Apr. 22, 2010

(54) MANAGING HOSTED VIRTUALIZED OPERATING SYSTEM ENVIRONMENTS

(75) Inventors: Kevin Lynn Fought, Round Rock, TX (US); Marc Joel Stephenson, Austin, TX (US)

Correspondence Address: IBM Corp. (GIG), c/o Garg Law Firm, PLLC, 4521 Copper Mountain Lane, Richardson, TX, 75082, US

(73) Assignee: INTERNATIONAL BUSINESS MACHINES CORPORATION, Armonk, NY (US)

(21) Appl. No.: 12/252,394

(22) Filed: Oct. 16, 2008

(51) Int. Cl. G06F 9/46

(52) U.S. Cl. 719/328

(57) ABSTRACT

A method, system, and computer usable program product for managing hosted virtualized operating system environments are provided in the illustrative embodiments. An instruction for an operation is received at a hosted virtual operating system environment. A server that is hosting the hosted virtual operating system environment is identified. The instruction is directed to the server to achieve the operation at the hosted virtual operating system environment. The instruction may be received at a network management component that may be in communication with the server and may interact with the server to instantiate the hosted virtual operating system environment. The server may be identified using a mapping information that may contain information about hosting relationships between a set of hosted virtual operating system environments and a set of servers. The instruction may be transformed to be executable on the server to achieve the operation at the hosted virtual operating system environment.

### BACKGROUND OF THE INVENTION

1. Field of the Invention

The present invention relates generally to an improved data processing system, and in particular, to a computer implemented method for managing data processing system partitions. Still more particularly, the present invention relates to a computer implemented method, system, and computer usable program code for managing hosted virtualized operating system environments.

2. Description of the Related Art

Data processing systems can be divided into logical partitions (LPAR). A logical partition is also known simply as a partition, and as a virtual machine. Each partition operates as a separate data processing system independent of the other partitions. Generally, a partition management firmware connects the various partitions and provides the network connectivity among them. Hypervisor is an example of such partition management firmware.

A partition includes a copy of an operating system. A partition also includes a set of computing resources that are available for that partition's use. A set of computing resources is one or more types of computing resources. A block of memory space is an example of a computing resource. A file in a file system is another example of a computing resource. Hard disk space, network bandwidth, one or more processors, processor cycles, and input/output (I/O) devices are some other examples of computing resources.

In a partitioned data processing environment, a partition, called the hosting partition, may host one or more virtual operating system environments. A hosted virtual operating system environment is a virtual data processing environment that appears to a user as a complete data processing system or partition that is separate from the hosting partition. Further, the hosted virtual operating system environment does not include a separate copy of the operating system but shares the operating system kernel of the hosting partition. A hosting partition is a partition that shares its operating system with one or more hosted virtual operating system environments. In other words, a hosting partition hosts a virtual operating system environment. Additionally, the hosting partition may share one or more computing resources of the hosting partition with any hosted virtual operating system environment. In certain data processing environments, such as partitions using a certain type of operating system, a hosted virtual operating system environment is also known as a workload partition (WPAR).

A user may desire to execute certain operations on a hosted virtual operating system environment. Operations on a hosted virtual operating system environment presently require the user to possess specific knowledge and perform several additional actions before the user can perform the operation on the hosted virtual operating system environment successfully. Therefore, an improved system, method, and product for managing hosted virtualized operating system environments will be desirable.

### SUMMARY OF THE INVENTION

The illustrative embodiments provide a method, system, and computer usable program product for managing hosted virtualized operating system environments. An instruction for an operation is received at a hosted virtual operating system environment. A server that is hosting the hosted virtual operating system environment is identified. The instruction is directed to the server to achieve the operation at the hosted virtual operating system environment.

In an embodiment, the instruction may be received at a network management component. The network management component may be in communication with the server. The network management component may interact with the server to instantiate the hosted virtual operating system environment.

In another embodiment, the server may be identified using a mapping information. The mapping information may contain information about hosting relationships between a set of hosted virtual operating system environments and a set of servers.

In another embodiment, the instruction may be transformed to form a transformed instruction. The transformed instruction may be executable on the server to achieve the operation at the hosted virtual operating system environment.

In another embodiment, the instruction may be an instruction to allocate a resource to the hosted virtual operating system environment. Further, the instruction may be transformed to form a transformed instruction to allocate the resource to the server such that upon execution of the transformed instruction the hosted virtual operating system environment receives access to the resource.

### BRIEF DESCRIPTION OF THE DRAWINGS

The novel features believed characteristic of the invention are set forth in the appended claims. The invention itself; however, as well as a preferred mode of use, further objectives and advantages thereof, will best be understood by reference to the following detailed description of an illustrative embodiment when read in conjunction with the accompanying drawings, wherein:

FIG. 1 depicts a block diagram of a data processing system in which the illustrative embodiments may be implemented;

FIG. 2 depicts a block diagram of an example logical partitioned platform in which the illustrative embodiments may be implemented;

FIG. 3 depicts a block diagram of a hosted virtual operating system environment in which the illustrative embodiments may be implemented;

FIG. 4 depicts a block diagram of a configuration for executing commands on hosted virtual operating system environments according to an illustrative embodiment;

FIG. 5 depicts a block diagram of a network management component in accordance with an illustrative embodiment;

FIG. 6 depicts another block diagram of a network management component according to an illustrative embodiment;

FIG. 7 depicts a flowchart of a process of managing hosted virtual operating system environments in accordance with an illustrative embodiment; and

FIG. 8 depicts a flowchart of another process of managing hosted virtual operating system environments in accordance with an illustrative embodiment.

### DETAILED DESCRIPTION OF THE PREFERRED EMBODIMENT

The illustrative embodiments described herein provide a method, system, and computer usable program product for managing hosted virtualized operating system environments. The illustrative embodiments recognize that certain operations with respect to a hosted virtual operating system environment have to be executed indirectly. In other words, certain operations targeted at a hosted virtual operating system environment have to be directed to the hosting partition. Consequently, the illustrative embodiments recognize that presently, managing hosted virtual operating system environments requires several additional operations for performing a function as compared to performing the same operation on a hosting partition.

For example, a user, such as a system administrator, may wish to install a software application on a hosted virtual operating system environment. The user has to know that the data processing system where the user desires to install the application is a hosted virtual operating system environment. The user also has to identify a hosting partition corresponding to the hosted virtual operating system environment. The user then has to direct the installation activity and any commands to the hosting partition. Further, the commands have to be directed to the hosting partition with instructions to execute corresponding commands on the hosted virtual operating system environment. The hosting partition in turn executes any corresponding commands on the hosted virtual operating system environment.

As another example, a user may desire to allocate certain computing resources to the data processing system the user may be using. If the data processing system is a hosted virtual operating system environment, the user may have to take different measures to perform the allocation as compared to if the data processing system is a hosting partition or a stand-alone data processing system. Thus, the illustrative embodiments recognize that performing an operation on a hosted virtual operating system environment presently requires a user to possess many pieces of information and perform many additional steps as compared to performing the same operation on a partition or other data processing system. For example, the user has to know the hosted virtual nature of the target data processing environment, the relationship of the target hosted virtual operating system environment to a hosting partition, ability and permissions to direct operations and commands to the hosting partition, knowledge of any additional steps or commands that must be directed to the hosting partition for successful execution on the hosted virtual operating system environment, and many other items of information.

Furthermore, hosted virtual operating system environments may be instantiated and terminated as needed, when needed, and where needed in a given partitioned data processing environment. Thus, the information about which hosted virtual operating system environments exist in relation to which hosting partition is constantly changing in such a data processing environment. For example, a hosted virtual operating system environment with certain identifiers may exist at a given time in a given data processing environment. The identifiers may be familiar to a user who may wish to perform an operation on the hosted virtual operating system environment.

The hosted virtual operating system environment, however, at the given time, may be associated with a different hosting partition as compared to the hosting partition that may have previously hosted the hosted virtual operating system environment. The illustrative embodiments recognize that if the user relies on the user's own knowledge of the hosted virtual operating system environment, the user may target the commands to an incorrect hosting partition and not achieve the desired operation at the hosted virtual operating system environment.

To address these and other problems associated with managing hosted virtual operating system environments, the illustrative embodiments provide an improved method, system, and computer usable program product for managing hosted virtual operating system environments. By using the illustrative embodiments, a user, a system, or an application may be able to interact with a hosted virtual operating system environment without having to know the specific nature of the data processing system or its relationship with other data processing system.

Any advantages listed herein are only examples and are not intended to be limiting on the illustrative embodiments. Additional or different advantages may be realized by specific illustrative embodiments. Furthermore, a particular illustrative embodiment may have some, all, or none of the advantages listed above.

The illustrative embodiments are described in some instances using particular data processing environments only as an example for the clarity of the description. The illustrative embodiments may be used in conjunction with other comparable or similarly purposed architectures for using virtualized real memory and managing virtual machines.

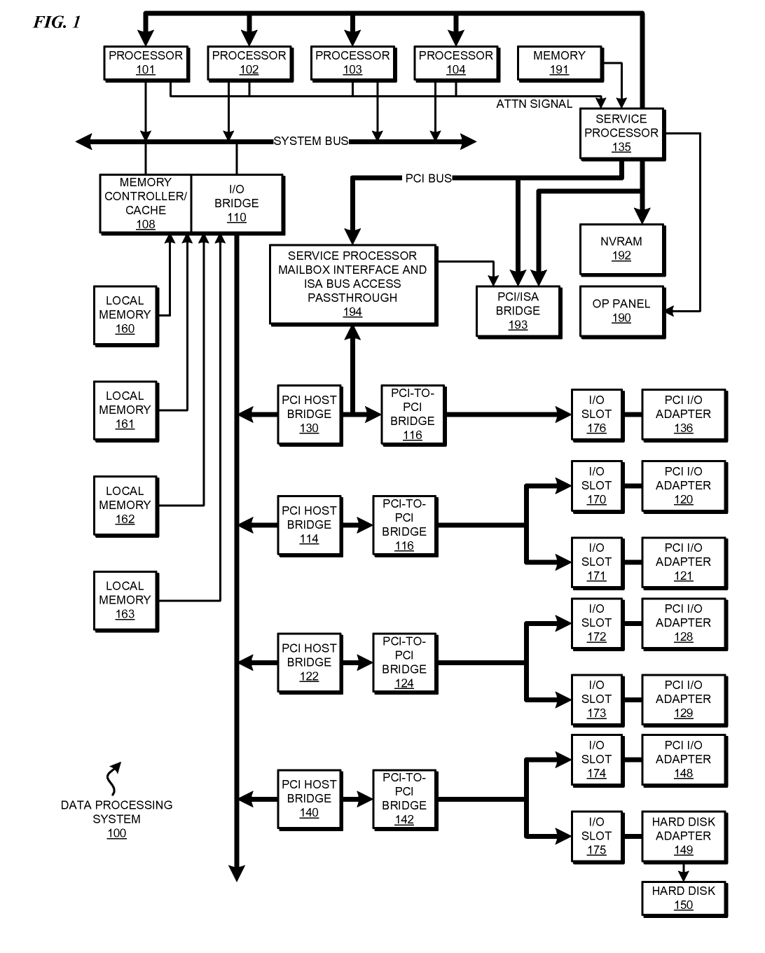

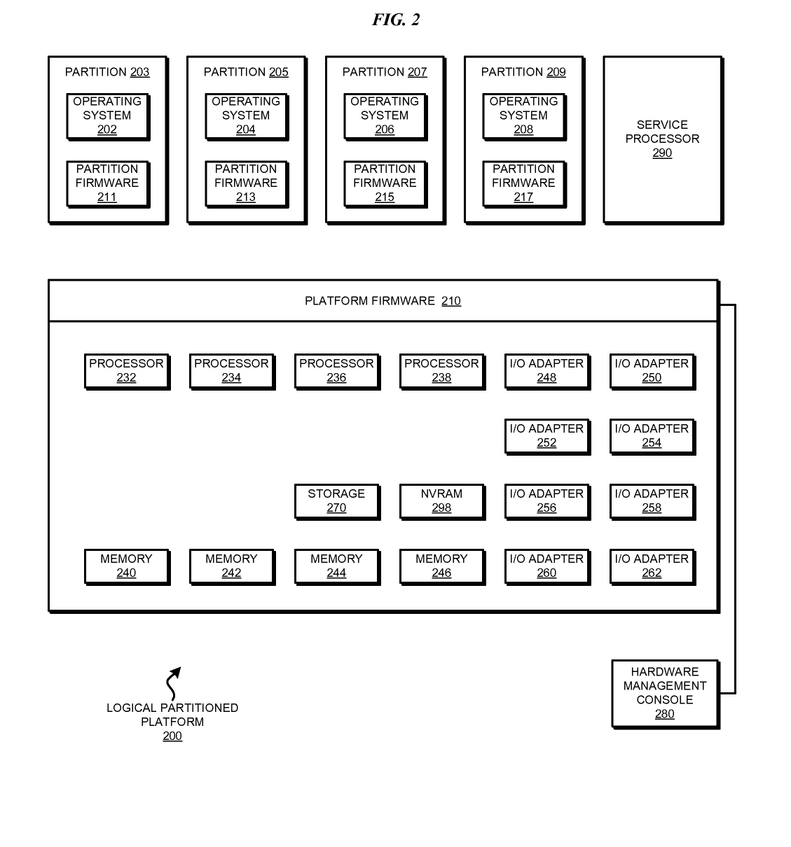

With reference to the figures and in particular with reference to FIGS. 1 and 2, these figures are example diagrams of data processing environments in which illustrative embodiments may be implemented. FIGS. 1 and 2 are only examples and are not intended to assert or imply any limitation with regard to the environments in which different embodiments may be implemented. A particular implementation may make many modifications to the depicted environments based on the following description.

With reference to FIG. 1, this figure depicts a block diagram of a data processing system in which the illustrative embodiments may be implemented. Data processing system 100 may be a symmetric multiprocessor (SMP) system including a plurality of processors 101, 102, 103, and 104, which connect to system bus 106. For example, data processing system 100 may be an IBM eServer® implemented as a server within a network. (eServer is a product and e(logo)server is a trademark of International Business Machines Corporation in the United States and other countries). Alternatively, a single processor system may be employed. Also connected to system bus 106 is memory controller/cache 108, which provides an interface to a plurality of local memories 160-163. I/O bus bridge 110 connects to system bus 106 and provides an interface to I/O bus 112. Memory controller/cache 108 and I/O bus bridge 110 may be integrated as depicted.

Data processing system 100 is a logical partitioned data processing system. Thus, data processing system 100 may have multiple heterogeneous operating systems (or multiple instances of a single operating system) running simultaneously. Each of these multiple operating systems may have any number of software programs executing within it. Data processing system 100 is logically partitioned such that different PCI I/O adapters 120-121, 128-129, and 136, graphics adapter 148, and hard disk adapter 149 may be assigned to different logical partitions. In this case, graphics adapter 148 connects for a display device (not shown), while hard disk adapter 149 connects to and controls hard disk 150.

Thus, for example, suppose data processing system 100 is divided into three logical partitions, P1, P2, and P3. Each of PCI I/O adapters 120-121, 128-129, 136, graphics adapter 148, hard disk adapter 149, each of host processors 101-104, and memory from local memories 160-163 is assigned to each of the three partitions. In these examples, memories 160-163 may take the form of dual in-line memory modules (DIMMs). DIMMs are not normally assigned on a per DIMM basis to partitions. Instead, a partition will get a portion of the overall memory seen by the platform. For example, processor 101, some portion of memory from local memories 160-163, and I/O adapters 120, 128, and 129 may be assigned to logical partition P1; processors 102-103, some portion of memory from local memories 160-163, and PCI I/O adapters 121 and 136 may be assigned to partition P2; and processor 104, some portion of memory from local memories 160-163, graphics adapter 148 and hard disk adapter 149 may be assigned to logical partition P3.

Each operating system executing within data processing system 100 is assigned to a different logical partition. Thus, each operating system executing within data processing system 100 may access only those I/O units that are within its logical partition. Thus, for example, one instance of the Advanced Interactive Executive (AIX®) operating system may be executing within partition P1, a second instance (image) of the AIX operating system may be executing within partition P2, and a Linux® or OS/400® operating system may be operating within logical partition P3. (AIX and OS/400 are trademarks of International business Machines Corporation in the United States and other countries. Linux is a trademark of Linus Torvalds in the United States and other countries).

Peripheral component interconnect (PCI) host bridge 114 connected to I/O bus 112 provides an interface to PCI local bus 115. A number of PCI input/output adapters 120-121 connect to PCI bus 115 through PCI-to-PCI bridge 116, PCI bus 118, PCI bus 119, I/O slot 170, and I/O slot 171. PCI-to-PCI bridge 116 provides an interface to PCI bus 118 and PCI bus 119. PCI I/O adapters 120 and 121 are placed into I/O slots 170 and 171, respectively. Typical PCI bus implementations support between four and eight I/O adapters (i.e. expansion slots for add-in connectors). Each PCI I/O adapter 120-121 provides an interface between data processing system 100 and input/output devices such as, for example, other network computers, which are clients to data processing system 100.

An additional PCI host bridge 122 provides an interface for an additional PCI bus 123. PCI bus 123 connects to a plurality of PCI I/O adapters 128-129. PCI I/O adapters 128-129 connect to PCI bus 123 through PCI-to-PCI bridge 124, PCI bus 126, PCI bus 127, I/O slot 172, and I/O slot 173. PCI-to-PCI bridge 124 provides an interface to PCI bus 126 and PCI bus 127. PCI I/O adapters 128 and 129 are placed into I/O slots 172 and 173, respectively. In this manner, additional I/O devices, such as, for example, modems or network adapters may be supported through each of PCI I/O adapters 128-129. Consequently, data processing system 100 allows connections to multiple network computers.

A memory mapped graphics adapter 148 is inserted into I/O slot 174 and connects to I/O bus 112 through PCI bus 144, PCI-to-PCI bridge 142, PCI bus 141, and PCI host bridge 140. Hard disk adapter 149 may be placed into I/O slot 175, which connects to PCI bus 145. In turn, this bus connects to PCI-to-PCI bridge 142, which connects to PCI host bridge 140 by PCI bus 141.

A PCI host bridge 130 provides an interface for a PCI bus 131 to connect to I/O bus 112. PCI I/O adapter 136 connects to I/O slot 176, which connects to PCI-to-PCI bridge 132 by PCI bus 133. PCI-to-PCI bridge 132 connects to PCI bus 131. This PCI bus also connects PCI host bridge 130 to the service processor mailbox interface and ISA bus access pass-through logic 194 and PCI-to-PCI bridge 132.

Service processor mailbox interface and ISA bus access pass-through logic 194 forwards PCI accesses destined to the PCI/ISA bridge 193. NVRAM storage 192 connects to the ISA bus 196. Service processor 135 connects to service processor mailbox interface and ISA bus access pass-through logic 194 through its local PCI bus 195. Service processor 135 also connects to processors 101-104 via a plurality of JTAG/I2C busses 134. JTAG/I2C busses 134 are a combination of JTAG/scan busses (see IEEE 1149.1) and Phillips I2C busses.

However, alternatively, JTAG/I2C busses 134 may be replaced by only Phillips I2C busses or only JTAG/scan busses. All SP-ATTN signals of the host processors 101, 102, 103, and 104 connect together to an interrupt input signal of service processor 135. Service processor 135 has its own local memory 191 and has access to the hardware OP-panel 190.

When data processing system 100 is initially powered up, service processor 135 uses the JTAG/I2C busses 134 to interrogate the system (host) processors 101-104, memory controller/cache 108, and I/O bridge 110. At the completion of this step, service processor 135 has an inventory and topology understanding of data processing system 100. Service processor 135 also executes Built-In-Self-Tests (BISTs), Basic Assurance Tests (BATs), and memory tests on all elements found by interrogating the host processors 101-104, memory controller/cache 108, and I/O bridge 110. Any error information for failures detected during the BISTs, BATs, and memory tests are gathered and reported by service processor 135.

If a meaningful/valid configuration of system resources is still possible after taking out the elements found to be faulty during the BISTs, BATs, and memory tests, then data processing system 100 is allowed to proceed to load executable code into local (host) memories 160-163. Service processor 135 then releases host processors 101-104 for execution of the code loaded into local memory 160-163. While host processors 101-104 are executing code from respective operating systems within data processing system 100, service processor 135 enters a mode of monitoring and reporting errors. The type of items monitored by service processor 135 include, for example, the cooling fan speed and operation, thermal sensors, power supply regulators, and recoverable and non-recoverable errors reported by processors 101-104, local memories 160-163, and I/O bridge 110.

Service processor 135 saves and reports error information related to all the monitored items in data processing system 100. Service processor 135 also takes action based on the type of errors and defined thresholds. For example, service processor 135 may take note of excessive recoverable errors on a processor's cache memory and decide that this is predictive of a hard failure. Based on this determination, service processor 135 may mark that resource for deconfiguration during the current running session and future Initial Program Loads (IPLs). IPLs are also sometimes referred to as a “boot” or “bootstrap”.

Data processing system 100 may be implemented using various commercially available computer systems. For example, data processing system 100 may be implemented using IBM eServer iSeries Model 840 system available from International Business Machines Corporation. Such a system may support logical partitioning using an OS/400 operating system, which is also available from International Business Machines Corporation.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the illustrative embodiments.

With reference to FIG. 2, this figure depicts a block diagram of an example logical partitioned platform in which the illustrative embodiments may be implemented. The hardware in logical partitioned platform 200 may be implemented as, for example, data processing system 100 in FIG. 1.

Logical partitioned platform 200 includes partitioned hardware 230, operating systems 202, 204, 206, 208, and platform firmware 210. A platform firmware, such as platform firmware 210, is also known as partition management firmware. Operating systems 202, 204, 206, and 208 may be multiple copies of a single operating system or multiple heterogeneous operating systems simultaneously run on logical partitioned platform 200. These operating systems may be implemented using OS/400, which are designed to interface with a partition management firmware, such as Hypervisor. OS/400 is used only as an example in these illustrative embodiments. Of course, other types of operating systems, such as AIX and Linux, may be used depending on the particular implementation. Operating systems 202, 204, 206, and 208 are located in partitions 203, 205, 207, and 209.

Hypervisor software is an example of software that may be used to implement partition management firmware 210 and is available from International Business Machines Corporation. Firmware is “software” stored in a memory chip that holds its content without electrical power, such as, for example, read-only memory (ROM), programmable ROM (PROM), erasable programmable ROM (EPROM), electrically erasable programmable ROM (EEPROM), and nonvolatile random access memory (nonvolatile RAM).

Additionally, these partitions also include partition firmware 211, 213, 215, and 217. Partition firmware 211, 213, 215, and 217 may be implemented using initial boot strap code, IEEE-1275 Standard Open Firmware, and runtime abstraction software (RTAS), which is available from International Business Machines Corporation. When partitions 203, 205, 207, and 209 are instantiated, a copy of boot strap code is loaded onto partitions 203, 205, 207, and 209 by platform firmware 210. Thereafter, control is transferred to the boot strap code with the boot strap code then loading the open firmware and RTAS. The processors associated or assigned to the partitions are then dispatched to the partition's memory to execute the partition firmware.

Partitioned hardware 230 includes a plurality of processors 232-238, a plurality of system memory units 240-246, a plurality of input/output (I/O) adapters 248-262, and a storage unit 270. Each of the processors 232-238, memory units 240-246, NVRAM storage 298, and I/O adapters 248-262 may be assigned to one of multiple partitions within logical partitioned platform 200, each of which corresponds to one of operating systems 202, 204, 206, and 208.

Partition management firmware 210 performs a number of functions and services for partitions 203, 205, 207, and 209 to create and enforce the partitioning of logical partitioned platform 200. Partition management firmware 210 is a firmware implemented virtual machine identical to the underlying hardware. Thus, partition management firmware 210 allows the simultaneous execution of independent OS images 202, 204, 206, and 208 by virtualizing all the hardware resources of logical partitioned platform 200.

Service processor 290 may be used to provide various services, such as processing of platform errors in the partitions. These services also may act as a service agent to report errors back to a vendor, such as International Business Machines Corporation. Operations of the different partitions may be controlled through a hardware management console, such as hardware management console 280. Hardware management console 280 is a separate data processing system from which a system administrator may perform various functions including reallocation of resources to different partitions.

The hardware in FIGS. 1-2 may vary depending on the implementation. Other internal hardware or peripheral devices, such as flash memory, equivalent non-volatile memory, or optical disk drives and the like, may be used in addition to or in place of certain hardware depicted in FIGS. 1-2. An implementation of the illustrative embodiments may also use alternative architecture for managing partitions without departing from the scope of the illustrative embodiments.

With reference to FIG. 3, this figure depicts a block diagram of a hosted virtual operating system environment in which the illustrative embodiments may be implemented. Hosting partition 302 may be any of partitions 203, 205, 207, or 209 in FIG. 2 and operating system 304 may be an operating system corresponding to the specific partition in FIG. 2.

Workload partition 306 may be a hosted virtual operating system environment according to the illustrative embodiments. Workload partition 306 may use shared operating system 308. Shared operating system 308 may be operating system 304 kernel executing processes for workload partition 306. Workload partition 310 may be another hosted virtual operating system environment similar to workload partition 306. Shared operating system 312 may be operating system 304 kernel executing processes for workload partition 310.

To a user, hosting partition 302, workload partition 306, and workload partition 310 may appear as three distinct data processing systems executing three distinct operating systems 304, 308, and 312 respectively. In operation, hosting partition 302, workload partition 306, and workload partition 310 may each utilize operating system 304 kernel for processing their respective computing work load.

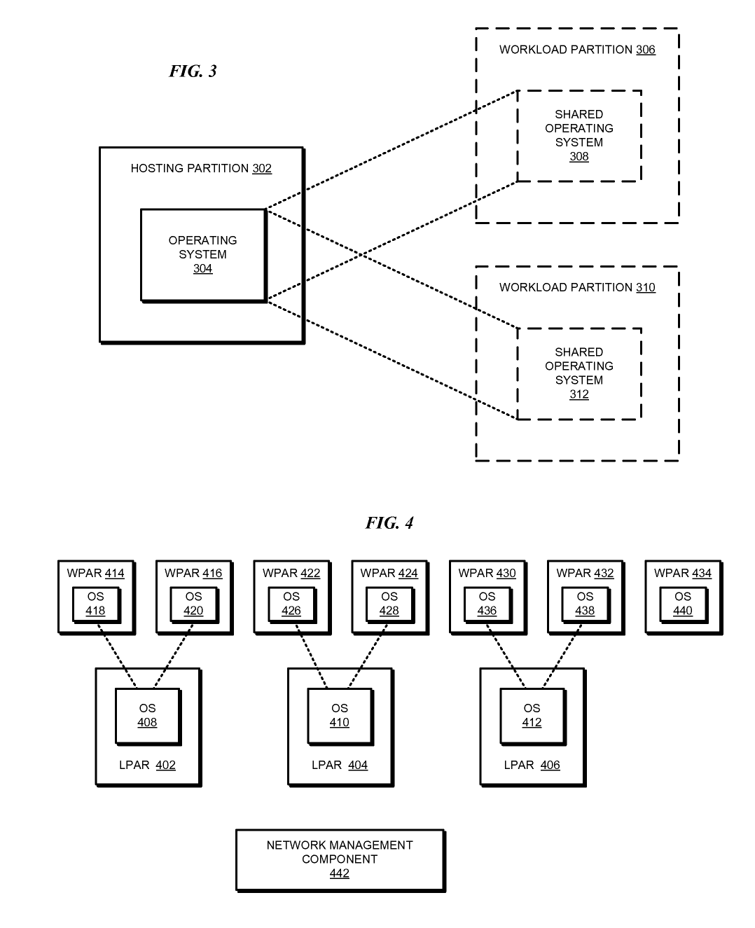

With reference to FIG. 4, this figure depicts a block diagram of a configuration for executing commands on hosted virtual operating system environments according to an illustrative embodiment. LPARs 402, 404, and 406 may each be an LPAR according to FIG. 2, such as any of partitions 203, 205, 207, and 209. Operating systems 408, 410, and 412 may each be an operating system dedicated to LPARs 402, 404, and 406 respectively as described with respect to FIGS. 2 and 3.

LPAR 402 may host WPARs 414 and 416. Operating system 418 of WPAR 414 and operating system 420 of WPAR 416 may each be shared operating systems that may share operating system 408 of hosting partition LPAR 402. Similarly, LPAR 404 may host WPARs 422 and 424. Operating system 426 of WPAR 422 and operating system 428 of WPAR 424 may each be shared operating systems that may share operating system 410 of hosting partition LPAR 404. LPAR 406 may host WPARs 430, 432, and 434. Operating system 436 of WPAR 430, operating system 438 of WPAR 432, and operating system 440 of WPAR 434 may each be shared operating systems that may share operating system 412 of hosting partition LPAR 406.

Network management component 442 may be a data processing system, a software application, or a combination thereof, that may be operable to manage a data processing environment including partitions. For example, network management component 442 may be a software application usable for instantiating and terminating WPARs hosted on LPARs 402, 404, and 406. Instantiating a WPAR is the process of creating and hosting a WPAR on a LPAR.

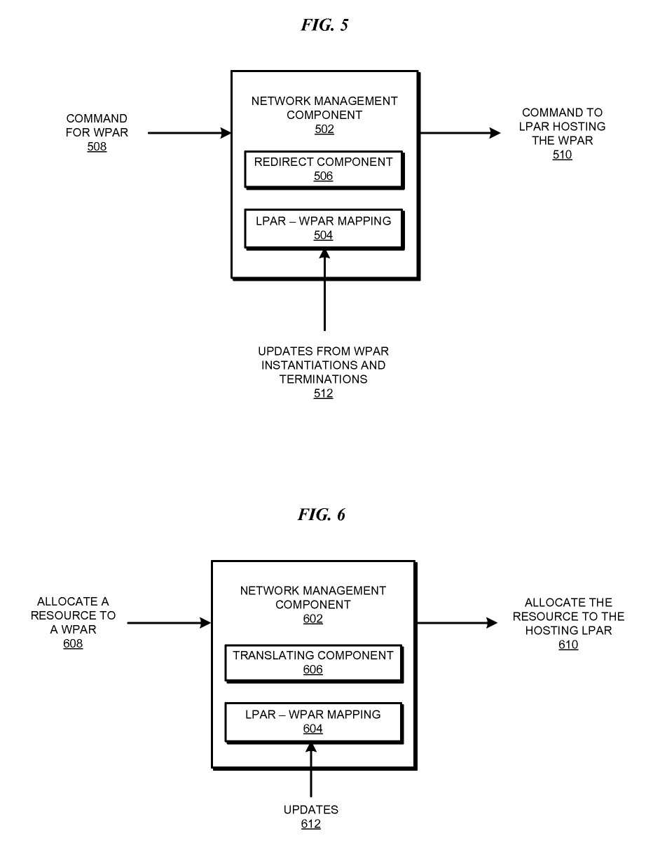

In one embodiment, IBM®'s AIX Network Installation Manager function may be used as network management component 442. Other comparable function or component in another operating system, or other applications operable as network management component 442 may exist for managing LPARs, and instantiating and terminating WPARs. Such network management components may be modified according to the illustrative embodiments to hide the relationships of the WPARs and LPARs from the user and facilitate the management of WPARs. Some of the modifications according to the illustrative embodiments are described in detail with respect to FIGS. 5 and 6.

With reference to FIG. 5, this figure depicts a block diagram of a network management component in accordance with an illustrative embodiment. Network management component 502 may be implemented using network management component 442 in FIG. 4.

Network management component 502 may be configured to access mapping information 504. Mapping information 504 may contain information about the relationships of various WPARs to their corresponding LPARs in a data processing environment. Using the depiction of FIG. 4 as an example, mapping information 504 may inform that WPAR 414 is hosted by LPAR 402, WPAR 416 is hosted by LPAR 402, and WPAR 422 is hosted by LPAR 404 in FIG. 4. Any number of such mapping information may be contained in mapping information 504.

Furthermore, mapping information 504 may provide such mapping information in any form suitable for a particular implementation. For example, in one embodiment, each LPAR and WPAR in a data processing environment may be identifiable by unique names. For example, two hosting servers in a data processing environment may be identified as “hosting server 1” and “Application server 5”. Similarly, two WPARs in the data processing environment may be identified as “virtual server 1” and “test server”. Mapping information 504 in such an embodiment may provide that virtual server 1 is hosted by hosting server 1 and test server is hosted by application server 5.

In another embodiment, the LPARs and WPARs in a data processing environment may be identified by their location in a network, such as by different addresses. Any method of identifying the data processing systems in a data processing environment may be used in conjunction with the illustrative embodiments without departing from the scope of the illustrative embodiments.

Additionally, mapping information 504 may be located within network management component 502, or be accessible to network management component 502 over a data network. Mapping information 504 may be implemented using a database, a flat file, an index file, or any other data structure suitable for storing information about the LPARs and WPARs. Network management component 502 may further include redirect component 506.

Configured in this manner, in operation, network management component 502 may receive command 508. For example, a user may direct command 508 to a WPAR managed by network management component 502. Network management component 502, having been modified with the illustrative embodiments, may look-up the WPAR target of command 508 using mapping information 504. Identifying the hosting LPAR of the target WPAR from mapping information 504, network management component 502 may use redirect component 506 to redirect command 508 or an equivalent thereof as command 510 to the hosting LPAR. The hosting LPAR may then execute command 510 for the target WPAR.

In one embodiment, redirect component 506 may simply send command 508 that was originally directed to a WPAR to a hosting LPAR of the WPAR. In another embodiment, redirect component 506 may manipulate and transform command 508 into a command that may be suitable for execution on the hosting LPAR to achieve the desired result of command 508 on the target WPAR. In another embodiment, redirect component 506 may perform these and other functions depending on the type of command 508 and other installation specific considerations.

From time to time, network management component 502 may receive updates 512 to mapping information 504. In one embodiment, network management component 502 may receive only the changes to mapping information 504 as updates 512. In another embodiment, updates 512 may include a complete replacement for mapping information 504. When mapping information 504 is accessible to network management component 502 over a data network, updates 512 may be directed to the system that may serve mapping information 504 to network management component 502.

With reference to FIG. 6, this figure depicts another block diagram of a network management component according to an illustrative embodiment. Network management component 602 may be implemented using network management component 502 in FIG. 5.

Network management component 602 may have access to mapping information 604 in a manner similar to network management component 502's access to mapping information 504 in FIG. 5. Translating component 606 may perform any translation, bifurcation, combining, or any other transformation to command 608. Translating component 606 may transform command 608 such that one or more command 610 may execute on the WPAR that was the target of command 608, a hosting LPAR of that WPAR, or a combination thereof. Updates 612 may modify mapping information 604 as described with respect to updates 512 in FIG. 5.

In this figure, as an example, command 608 is depicted as a command to allocate resources to a WPAR. For example, a user may wish to allow the WPAR access to a certain file in a file system. The user may issue command 608 to grant the WPAR the access. Recall that presently, the user has to know the hosting LPAR of the WPAR with which the user wishes to interact. Also recall that presently the user has to submit a command that is suitable for execution on or in favor of the LPAR even thought the user actually wishes the command to execute on or in favor of the WPAR.

By using the illustrative embodiments, network management component 602 transforms command 608 for granting access to a file to a WPAR into command 610 that grants access to the file to the hosting LPAR. The operating system kernel of the hosting LPAR then ensures that the target WPAR gets access to the file resource as the user had intended.

According to the illustrative embodiment depicted in FIG. 6, the user may be able to direct many variations of command 608 that may be targeted to many WPARs to network management component 602. Network management component 602 determines the hosting relationship of the target WPAR, and transforms and redirects the commands to the appropriate hosting LPAR. The user is thereby relieved from the burden of having to know how and with which LPAR to interact. Thus, the illustrative embodiments facilitate indirect resource allocation, command execution, and other management functions for WPARs in a data processing environment.

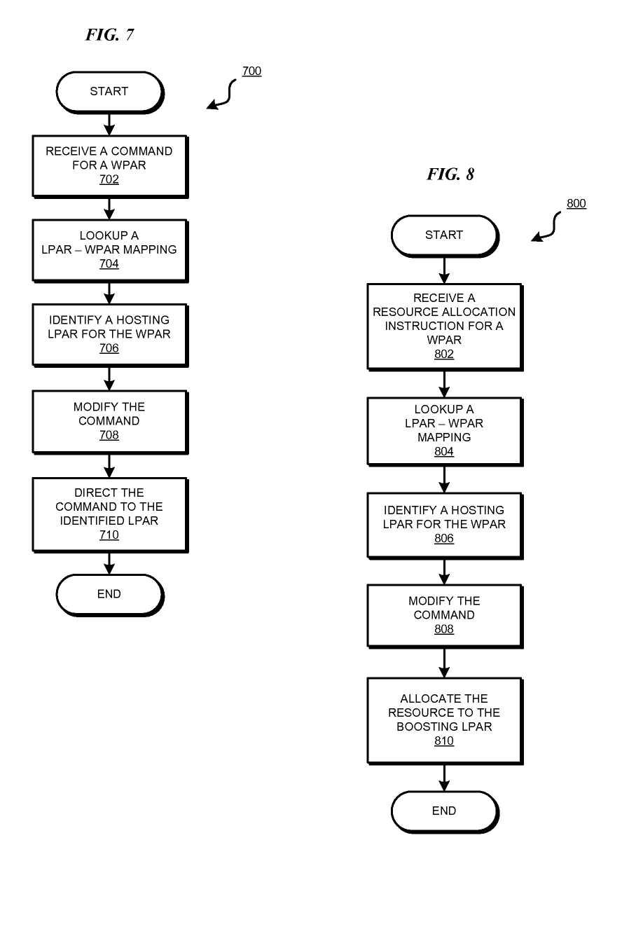

With reference to FIG. 7, this figure depicts a flowchart of a process of managing hosted virtual operating system environments in accordance with an illustrative embodiment. Process 700 may be implemented in a network management component, such as network management component 502 in FIG. 5.

Process 700 begins by receiving a command for a WPAR (step 702). Process 700 looks up a LPAR-WPAR mapping, such as by using mapping information 504 in FIG. 5 (step 704). Process 700 identifies a hosting LPAR for the WPAR of step 702 (step 706).

Process 700 may modify the command of step 702 such that the modified command may execute on the identified LPAR of step 706 (step 708). In one embodiment, the hosting LPAR may be able to execute the command of step 702 and step 708 may be omitted.

Process 700 directs the command, modified, or unmodified as an implementation may need, to the hosting LPAR identified in step 706 (step 710). Process 700 ends thereafter.

With reference to FIG. 8, this figure depicts a flowchart of another process of managing hosted virtual operating system environments in accordance with an illustrative embodiment. Process 800 may be implemented in a network management component, such as network management component 602 in FIG. 6.

Process 800 begins by receiving a resource allocation instruction for a WPAR (step 802). Process 800 looks up a LPAR-WPAR mapping, such as by using mapping information 604 in FIG. 6 (step 804). Process 800 identifies a hosting LPAR for the WPAR of step 802 (step 806).

Process 800 may modify the instruction of step 802 such that the modified command may execute on the identified LPAR of step 806 (step 808). In one embodiment, the hosting LPAR may be able to execute the instruction of step 802 and step 808 may be omitted.

Process 800 directs the instruction, modified or unmodified as an implementation may need, to the hosting LPAR identified in step 806 (step 810). Process 800 ends thereafter.

The components in the block diagrams and the steps in the flowcharts described above are described only as examples. The components and the steps have been selected for the clarity of the description and are not limiting on the illustrative embodiments. For example, a particular implementation may combine, omit, further subdivide, modify, augment, reduce, or implement alternatively, any of the components or steps without departing from the scope of the illustrative embodiments. Furthermore, the steps of the processes described above may be performed in a different order within the scope of the illustrative embodiments.

Thus, a computer implemented method, apparatus, and computer program product are provided in the illustrative embodiments for managing hosted virtual operating system environments. The illustrative embodiments may be implemented in data processing environments where hosted virtual operating system environments are used. Using the illustrative embodiments, users, systems, and applications in such a data processing environment may send commands or instructions to hosted virtual operating system environments without having to know the hosting relationships of the various hosted virtual operating system environments and the hosting servers, such as hosting partitions.

Furthermore, using the illustrative embodiments, the users, systems, and applications may perform operations with respect to hosted virtual operating system environments without knowing that the target system is a hosted virtual operating system environment and not an actual separate data processing system. Furthermore, in interacting with hosted virtual operating system environments, the users, systems, or application need not conform their operations, commands, or instructions to the hosted virtual operating system environments' hosting partitions' specifications.

Additionally, the illustrative embodiments allow instantiating, moving, relocating, and terminating hosted virtual operating system environments freely across a data processing environment without requiring users, systems, or applications to keep up with new associations and changed specifications. Thus, the illustrative embodiments offer a method, system, and computer usable program product for managing hosted virtual operating system environments in an improved manner over the presently available solutions.

The invention can take the form of an entirely hardware embodiment, an entirely software embodiment, or an embodiment containing both hardware and software elements. In a preferred embodiment, the invention is implemented in software, which includes but is not limited to firmware, resident software, and microcode.

Furthermore, the invention can take the form of a computer program product accessible from a computer-usable or computer-readable medium providing program code for use by or in connection with a computer or any instruction execution system. For the purposes of this description, a computer-usable or computer-readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include compact disk-read only memory (CD-ROM), compact disk-read/write (CD-R/W) and DVD.

Further, a computer storage medium may contain or store a computer-readable program code such that when the computer-readable program code is executed on a computer, the execution of this computer-readable program code causes the computer to transmit another computer-readable program code over a communications link. This communications link may use a medium that is, for example without limitation, physical or wireless.

A data processing system suitable for storing and/or executing program code will include at least one processor coupled directly or indirectly to memory elements through a system bus. The memory elements can include local memory employed during actual execution of the program code, bulk storage media, and cache memories, which provide temporary storage of at least some program code in order to reduce the number of times code must be retrieved from bulk storage media during execution.

A data processing system may act as a server data processing system or a client data processing system. Server and client data processing systems may include data storage media that are computer usable, such as being computer readable. A data storage medium associated with a server data processing system may contain computer usable code. A client data processing system may download that computer usable code, such as for storing on a data storage medium associated with the client data processing system, or for using in the client data processing system. The server data processing system may similarly upload computer usable code from the client data processing system. The computer usable code resulting from a computer usable program product embodiment of the illustrative embodiments may be uploaded or downloaded using server and client data processing systems in this manner.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to explain the principles of the invention, the practical application, and to enable others of ordinary skill in the art to understand the invention for various embodiments with various modifications as are suited to the particular use contemplated.

What is claimed is:

1. A computer implemented method for managing a hosted virtual operating system environment, the computer implemented method comprising:
receiving an instruction for an operation at a hosted virtual operating system environment;
identifying a server that is hosting the hosted virtual operating system environment; and
directing the instruction to the server to achieve the operation at the hosted virtual operating system environment.

2. The computer implemented method of claim 1, wherein the instruction is received at a network management component, the network management component being in communication with the server, and wherein the network management component interacts with the server to instantiate the hosted virtual operating system environment.

3. The computer implemented method of claim 1, wherein the server is identified using a mapping information, the mapping information containing information about hosting relationships between a set of hosted virtual operating system environments and a set of servers.

4. The computer implemented method of claim 1, further comprising:
transforming the instruction to form a transformed instruction, the transformed instruction being executable on the server to achieve the operation at the hosted virtual operating system environment.

5. The computer implemented method of claim 1, wherein the instruction is an instruction to allocate a resource to the hosted virtual operating system environment.

6. The computer implemented method of claim 5, further comprising:
transforming the instruction to form a transformed instruction to allocate the resource to the server such that upon execution of the transformed instruction the hosted virtual operating system environment receives access to the resource.

7. A computer usable program product comprising a computer usable medium including computer usable code for managing a hosted virtual operating system environment, the computer usable code comprising:
computer usable code for receiving an instruction for an operation at a hosted virtual operating system environment;
computer usable code for identifying a server that is hosting the hosted virtual operating system environment; and
computer usable code for directing the instruction to the server to achieve the operation at the hosted virtual operating system environment.

8. The computer usable program product of claim 7, wherein the instruction is received at a network management component, the network management component being in communication with the server, and wherein the network management component interacts with the server to instantiate the hosted virtual operating system environment.

9. The computer usable program product of claim 7, wherein the server is identified using a mapping information, the mapping information containing information about hosting relationships between a set of hosted virtual operating system environments and a set of servers.

10. The computer usable program product of claim 7, further comprising:
computer usable code for transforming the instruction to form a transformed instruction, the transformed instruction being executable on the server to achieve the operation at the hosted virtual operating system environment.

11. The computer usable program product of claim 7, wherein the instruction is an instruction to allocate a resource to the hosted virtual operating system environment.

12. The computer usable program product of claim 11, further comprising:
computer usable code for transforming the instruction to form a transformed instruction to allocate the resource to the server such that upon execution of the transformed instruction the hosted virtual operating system environment receives access to the resource.

13. A data processing system for managing a hosted virtual operating system environment, the data processing system comprising:
a storage device including a storage medium, wherein the storage device stores computer usable program code; and
a processor, wherein the processor executes the computer usable program code, and wherein the computer usable program code comprises:
computer usable code for receiving an instruction for an operation at a hosted virtual operating system environment;
computer usable code for identifying a server that is hosting the hosted virtual operating system environment; and
computer usable code for directing the instruction to the server to achieve the operation at the hosted virtual operating system environment.

14. The data processing system of claim 13, wherein the instruction is received at a network management component, the network management component being in communication with the server, and wherein the network management component interacts with the server to instantiate the hosted virtual operating system environment.

15. The data processing system of claim 13, wherein the server is identified using a mapping information, the mapping information containing information about hosting relationships between a set of hosted virtual operating system environments and a set of servers.

16. The data processing system of claim 13, further comprising:
computer usable code for transforming the instruction to form a transformed instruction, the transformed instruction being executable on the server to achieve the operation at the hosted virtual operating system environment.

17. The data processing system of claim 13, wherein the instruction is an instruction to allocate a resource to the hosted virtual operating system environment.

18. The data processing system of claim 17, further comprising:
computer usable code for transforming the instruction to form a transformed instruction to allocate the resource to the server such that upon execution of the transformed instruction the hosted virtual operating system environment receives access to the resource.
